(19) United States
(12) Patent Application Publication
(10) Pub. No.: US 2024/0113970 A1
(43) Pub. Date: Apr. 4, 2024

(54) NETWORK PATH DETERMINING METHOD AND APPARATUS, COMMUNICATION DEVICE AND STORAGE MEDIUM

(71) Applicant: BEIJING XIAOMI MOBILE SOFTWARE CO., LTD., Beijing (CN)

(72) Inventor: Dong CHEN, Beijing (CN)

(73) Assignee: BEIJING XIAOMI MOBILE SOFTWARE CO., LTD., Beijing (CN)

(21) Appl. No.: 18/275,212

(22) PCT Filed: Feb. 1, 2021
(86) PCT No.: PCT/CN2021/074723

§ 371 Date: Jul. 31, 2023

(51) Int. Cl. H04L 45/748; H04L 45/02; H04L 45/121

(52) U.S. Cl. CPC H04L 45/748; H04L 45/02; H04L 45/121

(57) ABSTRACT

A network path determining method includes: receiving a data transmission request, the data transmission request includes a destination address and delay information, and the delay information indicates a delay duration allowed by the data transmission request; and selecting, based on the destination address and the delay information, a data transmission path for reaching the destination address and with a time delay less than or equal to the delay duration.

### CROSS-REFERENCE TO RELATED APPLICATION

The present application is the U.S. National Stage of International Application No. PCT/CN2021/074723, filed on Feb. 1, 2021, the contents of which are incorporated herein by reference in their entireties for all purposes.

### BACKGROUND

An Internet protocol (IP) address is a protocol for transmitting information between networks. The IP information packet may be transmitted from a source device, such as a user computer, to a destination device, such as a server in a department or another computer. To achieve this goal, the IP needs to rely on two mechanisms, IP addressing and IP routing.

The IP specifies that all devices in the network must have a unique IP address, just as a mail must indicate the recipient's address on it in order for a mailman to deliver it. Similarly, each IP information packet must contain an IP address of a destination device in order for the IP information packet to be properly delivered to its destination. The same device may have more than one IP address, i.e., a network device using the IP may have at least one unique IP address. The Internet is a large network formed by many networks through connecting. If an IP information packet is to be transmitted across the Internet, in addition to ensuring that each device in the network has a unique IP address, there must be a transmission mechanism between the networks in order to transmit the IP information packet through the individual networks to the destination; and this transmission mechanism is called IP routing. Each network is connected to another network through a router, and the function of the router is to select the transmission path for the IP information packet; that is to say, it is necessary to rely on the cooperation of each router to transmit the IP information packet to the destination address.

However, in the related arts, after the information packet is sent by a sender user equipment (UE), the sender UE does not know the path of routers passed through or the like and the processing duration at each router. As a result, the network, such as the sender UE, has no control over the path for the transmission of the information packet, the processing duration at the router, and/or the duration for the information packet to reach the destination address from the source address, causing that the time when the information packet reaches the destination address, etc., is not accurately known.

### SUMMARY

The present disclosure relates to, but is not limited to, the field of communication technologies, and in particular relates to a network path determining method and apparatus, a communication device and a storage medium.

According to a first aspect of the embodiments of the present disclosure, a network path determining method is provided. The method is applied to a router, and includes:
receiving a data transmission request, the data transmission request includes a destination address and delay information, and the delay information indicates a delay duration allowed by the data transmission request; and
selecting, based on the destination address and the delay information, a data transmission path for reaching the destination address and with a time delay less than or equal to the delay duration.

According to a second aspect of the embodiments of the present disclosure, a network path determining method is provided. The method is applied to a UE, and includes sending a data transmission request, the data transmission request includes a destination address and delay information, and the delay information indicates a delay duration allowed by the data transmission request.

Information of the destination address and the delay information are used for a router to select a data transmission path for reaching the destination address and with a time delay less than or equal to the delay duration.

According to a third aspect of the embodiments of the present disclosure, a communication device is provided. The communication device includes:
a processor; and
a memory, configured to store an executable instruction executable by the processor.

The processor, when executing the executable instruction, is configured to implement the network path determining method according to any one of embodiments of the present disclosure.

According to a fourth aspect of the embodiments of the present disclosure, a computer storage medium is provided. The computer storage medium stores a computer executable program, and the executable program, when executed by a processor, implements the network path determining method according to any one of embodiments of the present disclosure.

It should be understood that the above general description and the later detailed description are only illustrative and explanatory and do not limit the embodiments of the present disclosure.

### BRIEF DESCRIPTION OF THE DRAWINGS

FIG. 1 is a schematic structure diagram of a wireless communication system according to an embodiment of the present disclosure.

FIG. 2 is a schematic structure diagram of a network system according to an embodiment of the present disclosure.

FIG. 3 is a schematic structure diagram of a network system according to an embodiment of the present disclosure.

FIG. 4 is a schematic diagram of a network path determining method illustrated according to an embodiment of the present disclosure.

FIG. 5 is a schematic diagram of a network path determining method illustrated according to an embodiment of the present disclosure.

FIG. 6 is a schematic diagram of a network path determining method illustrated according to an embodiment of the present disclosure.

FIG. 7 is a schematic diagram of a network path determining method illustrated according to an embodiment of the present disclosure.

FIG. 8 is a schematic diagram of a network path determining method illustrated according to an embodiment of the present disclosure.

FIG. 9 is a schematic diagram of a network path determining method illustrated according to an embodiment of the present disclosure.

FIG. 10 is a schematic diagram of a network path determining method illustrated according to an embodiment of the present disclosure.

FIG. 11 is a block diagram of a network path determining apparatus illustrated according to an embodiment of the present disclosure.

FIG. 12 is a block diagram of a network path determining apparatus illustrated according to an embodiment of the present disclosure.

FIG. 13 is a block diagram of a UE illustrated according to an embodiment of the present disclosure.

FIG. 14 is a block diagram of a base station illustrated according to an embodiment of the present disclosure.

### DETAILED DESCRIPTION

Embodiments will be described herein in detail, examples of which are represented in the accompanying drawings. Where the following description relates to the accompanying drawings, the same numerals in the different accompanying drawings indicate the same or similar elements unless otherwise indicated. The implementations described in the following embodiments do not represent all implementations consistent with the present disclosure. On the contrary, they are only examples of apparatus and methods that are consistent with some aspects of the present disclosure as detailed in the appended claims.

The terms used in the present disclosure are for the purpose of describing particular embodiments only and are not intended to limit the embodiments of the present disclosure. The singular forms of “a” and “the” as used in the embodiments and the appended claims of the present disclosure are also intended to include the majority forms, unless the context clearly indicates other meanings. It should also be understood that the term “and/or” as used herein refers to and includes any or all possible combinations of one or more of the associated listed items.

It should be understood that although the terms first, second, third, etc., may be used in the embodiments of the present disclosure to describe various information, such information should not be limited to these terms. These terms are used only to distinguish the same type of information from one another. For example, without departing from the scope of the embodiments of the present disclosure, the first information may also be referred to as the second information, and similarly, the second information may also be referred to as the first information. Depending on the context, for example, the word “if” as used herein may be interpreted as “in the case of . . . ” or “when . . . or” “in response to determining”.

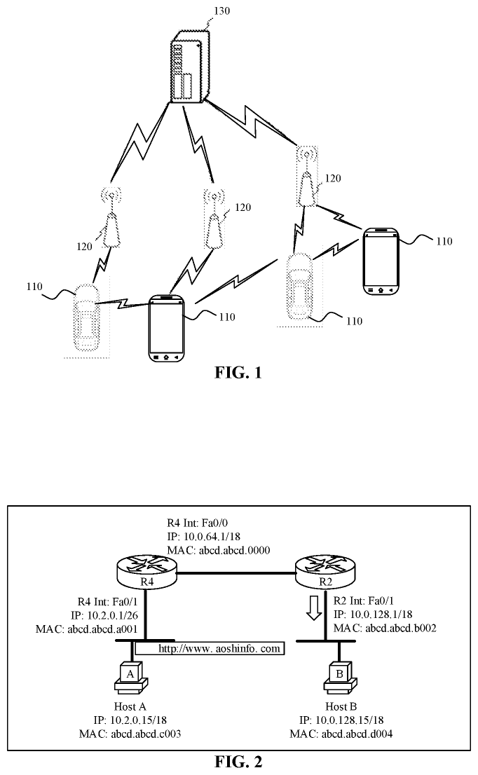

Referring to FIG. 1, a schematic structure diagram of a wireless communication system provided by an embodiment of the present disclosure is shown. As shown in FIG. 1, the wireless communication system is a communication system based on a cellular mobile communication technology, and may include several UE 110 and several base stations 120.

The UE 110 may be a device that provides voice and/or data connectivity to a user. The UE 110 may communicate with one or more core networks through a radio access network (RAN). The UE 110 may be an IoT UE, such as a sensor device, a mobile phone (or a “cellular” phone), or a computer with an IoT UE. For example, the UE 110 may be a fixed, portable, pocket, handheld, computer built-in, or vehicle-mounted device. For example, the UE 110 may be a station (STA), subscriber unit, subscriber station, mobile station, mobile, remote station, access point, remote terminal, access terminal, user terminal, user agent, user device or user equipment. Alternatively, the UE 110 may be a device of an unmanned aerial vehicle. Alternatively, the UE 110 may be a vehicle-mounted device, such as a trip computer with a wireless communication function or a wireless UE externally connected to a trip computer. Alternatively, the UE 110 may be a road side device, such as a street light, signal light, or other road side devices with a wireless communication function.

The base station 120 may be a network-side device in the wireless communication system. The wireless communication system may be the 4th generation mobile communication (4G) system, also known as the long term evolution (LTE) system. Alternatively, the wireless communication system may be a 5G system, also known as a new radio system or a 5G NR system. Alternatively, the wireless communication system may be the next generation system of the 5G system. The access network in the 5G system may be called the new generation-radio access network (NG-RAN).

The base station 120 may be an evolved base station (eNB) used in a 4G system. Alternatively, the base station 120 may be a base station (gNB) with a centralized distributed architecture in a 5G system. When adopting the centralized distributed architecture, the base station 120 typically includes a central unit (CU) and at least two distributed units (DUs). The central unit is provided with a protocol stack of a packet data convergence protocol (PDCP) layer, a radio link control (RLC) layer, and a media access control (MAC) layer. The distributed unit is provided with a protocol stack of a physical (PHY) layer. The embodiments of the present disclosure do not limit the specific implementations of the base station 120.

A wireless connection may be established between the base station 120 and the UE 110 via a wireless air interface. In a different implementation, the wireless air interface is based on the 4th generation mobile communication network technology (4G) standard. Alternatively, the wireless air interface is based on the 5th generation mobile communication network technology (5G) standard, for example, the wireless air interface is a new air interface. Alternatively, the wireless air interface may also be based on the next generation mobile communication network technology standard of 5G.

In some embodiments, an end to end (E2E) connection may also be established between UE 110, for example, scenarios such as a vehicle to vehicle (V2V) communication, vehicle to infrastructure (V2I) communication, and vehicle to pedestrian (V2P) communication, in vehicle to everything (V2X) communications.

In some embodiments, the aforementioned UE may be considered as a terminal device in the following embodiments.

In some embodiments, the aforementioned wireless communication system may further include a network management device 130.

Several base stations 120 are respectively connected to the network management device 130. The network management device 130 may be a core network device in the wireless communication system, e.g., the network management device 130 may be a mobility management entity (MME) in an evolved packet core (EPC). Alternatively, the network management device may be other core network devices, such as a serving gateway (SGW), public data network gateway (PGW), policy and charging rules function (PCRF), or home subscriber server (HSS). The implementation forms of the network management device 130 are not limited by the embodiments of the present disclosure.

In order to better understand the technical solutions described in any embodiment of the present disclosure, the transmission of the IP information packet in the network is first described.

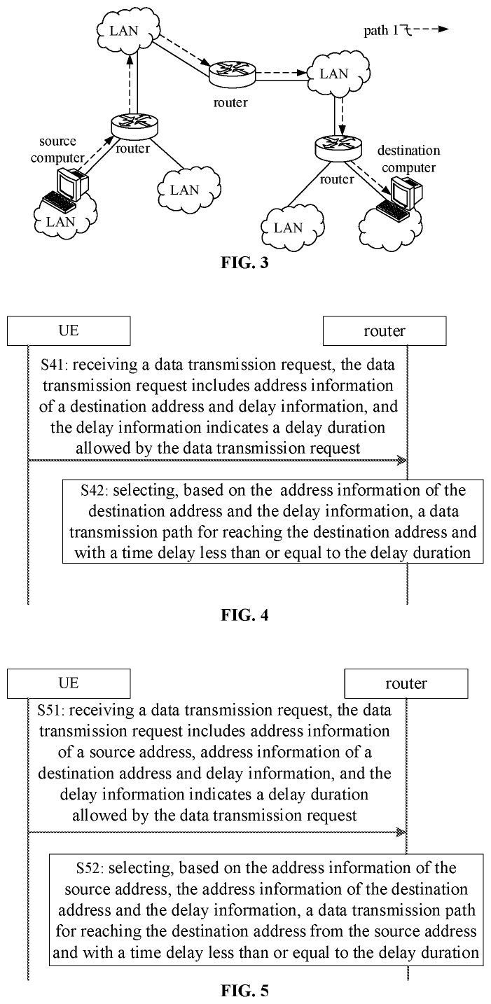

In some embodiments, as shown in FIGS. 2 and 3, various networks in the Internet are connected to each other through routers; and the router is used for selecting a path for the transmission of the IP information packet. The IP information packet may carry an IP address, a physical (MAC) address, and a network type, etc. The transmission of the IP information packet requires the cooperation of each router to transmit the IP information packet to the destination address. For example, in FIG. 3, an IP information packet is transmitted from a source computer to a destination computer, and the IP information packet may pass through path 1 as shown in FIG. 3.

In an embodiment, the IP information packet may include a source address and a destination address. For example, the format of an IP information packet is shown in Table 1 below, and the IP information packet includes the source address, destination address, version, header length, differentiated service, total length, identification, flag, fragment offset, time to live, and protocol.

TABLE 1

| Version | Header | Differentiated | Total Length |
|---|---|---|---|
| | Length | Service | |

| | | |
|---|---|---|
| Identification | Flag | Fragment Offset |

| | | |
|---|---|---|
| Time To Live | Protocol | Header Checksum |

Source Address
Destination Address

| | |
|---|---|
| Optional Field (Variable Length) | Padding |

After an existing IP information packet is sent by the sender UE, the sending end UE cannot know the path for the transmission of the IP information packet and the time when the IP information packet reaches the destination address.

As shown in FIG. 4, an embodiment of the present disclosure provides a network path determining method. The method is applied to a router, and includes the following steps S41 to S42.

At step S41, a data transmission request is received. The data transmission request includes a destination address and delay information, and the delay information indicates a delay duration allowed by the data transmission request.

At step S42, a data transmission path for reaching the destination address and with a time delay less than or equal to the delay duration is selected based on the destination address and the delay information.

In some embodiments, the router may connect to any device that serves as a gateway. For example, the router may be a hardware device that connects any two or more networks, and serve as a gateway.

In some embodiments, the router includes, but is not limited to, one of the following: a first-hop router, an intermediate-hop router, and a last-hop router. In an Internet, the first-hop router herein is a router connected to the sender UE; the intermediate-hop router herein is a router connected neither to the sender UE nor to the receiver UE; and the last-hop router herein is a router connected to the receiver UE. The identities of the first-hop router, the intermediate-hop router and the last-hop router herein are interchangeable in different data transmission paths. Thus, in this embodiment, if the router in the step S41 is the first-hop router, the determination of the data transmission path, of the information packet, for reaching the destination address from the first-hop router or the source address may be realized; or, if the router in the step S41 is an arbitrary intermediate-hop router, the determination of the data transmission path, of the information packet, for reaching the destination address from an arbitrary intermediate-hop router may be realized; or, if the router in the step S41 is the last-hop router, the determination of the data transmission path, of the information packet, for reaching the destination address from the last-hop router may be realized.

In an embodiment, the sender UE is a UE that sends an information packet, and the receiver UE is a UE that receives the information packet. In another embodiment, the sender UE may be a UE indicated by the source address, and the receiver UE may be a UE indicated by the destination address.

In some embodiments, the UE may be various mobile terminals or fixed terminals. For example, the UE may be, but is not limited to, a cell phone, a computer, a server, a wearable device, a game control platform, or a multimedia device.

In some embodiments, address information of a device may be used for uniquely identifying an address of the device. For example, the address information includes, but is not limited to, one of the following: an IP address or a MAC address. For example, the address information of the router may be, IP: 10.11.64.1, or the address information of the router may be, MAC: abcd.abcd.0000, and so on. For another example, the address information of the router may also be any address information indicating the location where the router is located in the network; for example, the address information of the router may be, INT4.104, where “INT4” is used for indicating that the router is in the 4th network, and “104” is used for indicating that it is the 104th router.

The address information herein at least includes address information of the destination address and/or the source address. The destination address herein refers to the address of the device that receives the information packet, and the address information of the source address herein refers to the address of the device sending the information packet. The identities of the source address and the destination address herein are interchangeable in different paths for the transmission of the information packet.

In an embodiment, the delay duration may be a total delay duration allowed by the data transmission request. In this way, in this embodiment, the router may know the delay duration allowed for reaching the destination address from the sender UE.

In another embodiment, the delay duration may be a delay duration for reaching the destination address from the current router. In this way, in this embodiment, the router may know the delay duration allowed for reaching the destination address from the current router.

Of course, in other embodiments, the delay duration may also be the delay duration allowed for reaching the destination address from any one or more routers in the data transmission path; or the delay duration may also be the delay duration allowed for reaching the destination address from any one or more routers in the network.

The network path determining method provided by an embodiment of the present disclosure may include: receiving, by the first-hop router, the data transmission request sent by the sender UE.

In some embodiments, the data transmission path includes one or more. Herein, any path that satisfies that a time delay, of an information packet, for reaching the destination address is less than or equal to the delay duration may be the data transmission path in this embodiment.

In some embodiments, the data transmission path includes an address of a router passed through for reaching the destination address.

In an example, the data transmission path includes: an address of router 1 and the destination address.

In some embodiments, the data transmission path includes: a plurality of addresses of routers through which the destination address is reached.

In one example, the data transmission path includes: the address of router 1, the address of router 2 . . . the address of router N, and the destination address, where N is an integer greater than 1.

In an embodiment, the address of the router passed through in the data transmission path described above may also be indicated by a flow table.

In an embodiment, the time delay includes a processing delay and a transmission delay.

The processing delay is used for indicating a duration of data processing performed by the router.

The transmission delay is used for indicating at least one of: a duration of reaching the first-hop router from a sender UE, a duration of reaching the next-hop router from the previous-hop router, and a duration of reaching a receiver UE from the last-hop router.

In an example, if the data transmission path includes an address of router 1 and the destination address, the time delay includes a duration of data processing performed by router 1 and a duration of reaching the UE indicated by the destination address from router 1; alternatively, the time delay includes a duration of reaching router 1 from the sender UE, a duration of data processing performed by router 1, and a duration of reaching the UE indicated by the destination address from router 1.

In an example, if the data transmission path includes an address of router 1, an address of router 2, and the destination address, the time delay includes a duration of data processing performed by router 1, a duration of reaching router 2 from router 1, a duration of data processing performed by router 2, and a duration of reaching the UE indicated by the destination address from router 2; alternatively, the time delay includes a duration of reaching router 1 from the sender UE, a duration of data processing performed by router 1, a duration of reaching router 2 from router 1, a duration of data processing performed by router 2, and a duration of reaching the UE indicated by the destination address from router 2.

In this way, in the embodiment of the present disclosure, the actual time delay required for the information packet to reach the destination address may be determined based on the duration of processing performed by the router passed through by the information packet in the data transmission path, and the duration of transmission of the information packet between adjacent devices (routers or UE) in the data transmission path. Therefore, based on the comparison between the actual required time delay and the delay duration allowed by the data transmission request, as long as the actual required time delay is less than or equal to the allowed delay duration of the information packet indicated by the data transmission request, the suitable data transmission path for the information packet to reach the destination address may be determined.

In some embodiments, if the router is the first-hop router, the above step S41 may be: receiving the data transmission request sent by the sender UE. In other embodiments, if the router is the intermediate-hop router or the last-hop router, the above step S41 may be: receiving the data transmission request sent by the previous-hop router. Thus, in these embodiments of the present disclosure, in the internet, each router may determine the data transmission path, of the information packet, for reaching the destination address from the router itself, making the transmission path and/or time delay of the information packet controllable.

In an embodiment of the present disclosure, the router determines the data transmission path for reaching the destination address, and the time delay of reaching the destination address may be directly determined based on the data transmission path.

In an embodiment of the present disclosure, the data transmission request including the destination address and the delay information may be received by a router, and the data transmission path for reaching the destination address and with the time delay less than or equal to the delay duration may be selected by the router based on the destination address and the delay information. In this way, the embodiments of the present disclosure are able to accurately determine the data transmission path for the data transmission and the time delay for the data transmission, e.g., accurately determining the router passed through by the information packet for reaching the destination address, and determining the time delay for reaching the destination address, etc.

The methods provided by an embodiment of the present disclosure may be performed alone, or in conjunction with some of the methods of the other embodiments of the present disclosure or some of the methods of the related arts.

As shown in FIG. 5, an embodiment of the present disclosure provides a network path determining method. The method is applied to a router, and includes the following steps S51 to S52.

At step S51, a data transmission request is received. The data transmission request includes address information of a source address, a destination address and delay information, and the delay information indicates a delay duration allowed by the data transmission request.

At step S52, a data transmission path for reaching the destination address from the source address and with a time delay less than or equal to the delay duration is selected based on the address information of the source address, the destination address and the delay information.

In some embodiments of the present disclosure, the address information may be the address information described in the step S41; and/or, the delay duration may be the delay duration described in the step S41; and/or, the time delay may be the time delay described in the step S42; and/or, the data transmission path may be the data transmission path described in the step S42; and these contents are not repeated herein.

Of course, in some embodiments of the present disclosure, the address information, the delay information, the time delay, and/or the data transmission path may also be other information.

In some embodiments, the data transmission path includes: the source address, an address of a router passed through for reaching the destination address, and the destination address.

In an example, the data transmission path includes: the source address, an address of router 1, and the destination address. In this example, the time delay may include: a duration of reaching router 1 from the UE indicated by the source address, a duration of data processing performed by router 1, and a duration of reaching the UE indicated by the destination address from router 1.

In other embodiments, the data transmission path includes: the source address, a plurality of addresses of routers passed through for reaching the destination address, and the destination address.

In an example, the data transmission path includes: the source address, an address of router 1, an address of router 2 . . . an address of router N, and the destination address, where N is an integer greater than 1. In this example, the time delay may include: a duration of reaching router 1 from the UE indicated by the source address, a duration of data processing performed by router 1, a duration of reaching router 2 from router 1; and so on, a duration of data processing performed by router N, and a duration of reaching the destination address from router N.

In an embodiment of the present disclosure, the actual time delay required for the information packet to reach the destination address from the source address may be determined based on the duration of processing performed by the router passed through by the information packet in the data transmission path, and the duration of transmission of the information packet between adjacent devices (routers or UE) in the data transmission path.

In some embodiments, the data transmission request in the step S41 further includes the address information of the source address; and the step S42 includes: selecting, based on the address information of the source address, the destination address and the delay information, the data transmission path for reaching the destination address from the source address and with the time delay less than or equal to the delay duration.

In an embodiment of the present disclosure, the data transmission request including the source address, the destination address and the delay information may be received by a router, and the data transmission path for reaching the destination address and with the time delay less than or equal to the delay duration may be selected by the router based on the source address, the destination address and the delay information. In this way, the embodiments of the present disclosure are able to accurately determine the data transmission path for the data to reach the destination address from the source address, and determine the time delay for the data transmission, e.g., accurately determining the router passed through by transmission of the information packet for reaching the destination address from the source address, and determining the time delay for reaching the destination address, etc.

The methods provided by an embodiment of the present disclosure may be performed alone, or in conjunction with some of the methods of the other embodiments of the present disclosure or some of the methods of the related arts.

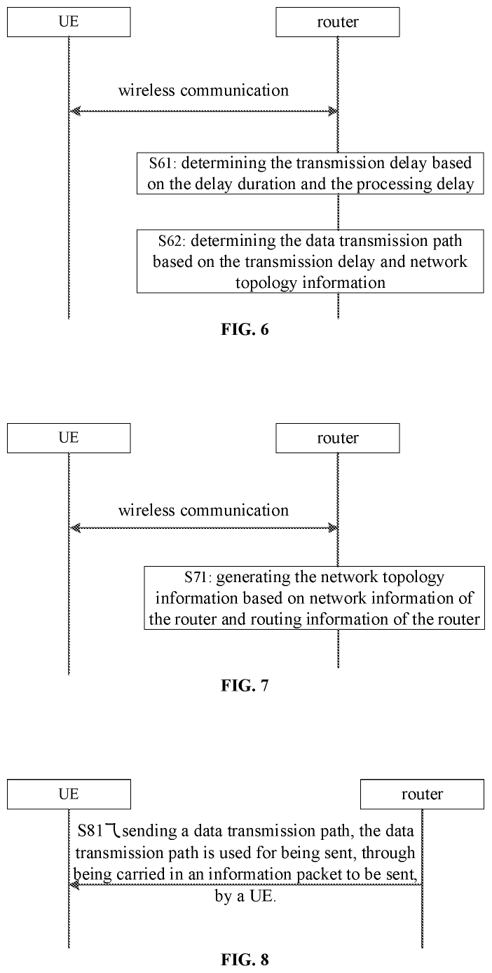

As shown in FIG. 6, an embodiment of the present disclosure provides a network path determining method. The method is applied to a router, and includes the following steps S61 to S62.

At step S61, the transmission delay is determined based on the delay duration and the processing delay.

At step S62, the data transmission path is determined based on the transmission delay and network topology information.

In some embodiments, the network topology information may include, but is not limited to, at least one of the following: the duration(s) of data processing performed by the router(s), the duration of reaching the first-hop router from the sender UE, the duration of reaching the next-hop router from the previous-hop router, the duration of reaching the receiver UE from the last-hop router, the address(es) of the router(s), the source address, and the destination address.

In an example, a router obtains the delay duration in the data transmission request as T, determines the data transmission path as L1, obtains the processing delay T1 of the routers passed through in the data transmission path L1, and determines the transmission delay, of the routers that the information packet needs to pass through for reaching the destination address, as T2=T-T1; the router determines the transmission delay, of the data transmission path L1 from the network topology information, as T3; if T2 is greater than or equal to T3, it is determined that the information packet may reach the destination address based on the data transmission path L1.

In an embodiment of the present disclosure, the processing delay in the step S51 may be obtained from the storage information of the router, or may be obtained from the network topology information. Alternatively, the processing delay in the step S51 may be obtained from the sender UE. If the processing delay time is obtained from the network topology information, a network path determining method provided by an embodiment of the present disclosure may include: determining the data transmission path based on the delay duration and the network topology information.

In an embodiment, the network topology information includes a network topology map. The network topology map at least includes: the transmission delays of adjacent routers and the processing delays of the routers. Of course, in other embodiments, the network topology map may also include a transmission delay for reaching the destination address from the last-hop router; or, the network topology map may also include: a transmission delay for reaching the first-hop router from the sender UE, and a transmission delay for reaching the destination address from the last-hop router.

An embodiment of the present disclosure provides a network path determining method. The method may include:
receiving the data transmission request, the data transmission request includes the destination address and the delay information, where the delay information indicates the delay duration allowed by the data transmission request;
determining the transmission delay based on the delay duration and the processing delay; and
determining the data transmission path based on the transmission delay and the network topology information.

In the embodiment of the present disclosure, a router may determine the data transmission path by obtaining the delay duration in the data transmission request and the network topology information, causing that a data transmission path for an information packet to satisfy a delay requirement may be determined efficiently and accurately, and making the transmission path for the information packet controllable. Moreover, after the data transmission path for the transmission of the information packet is determined, the processing delay and the transmission delay that the information packet undergoes may be accurately determined respectively, thereby realizing that the time delay for the information packet to reach the destination address is controllable.

An embodiment of the present disclosure provides a network path determining method. The method may include:
searching for, from the network topology information and based on the destination address and the delay duration in the data transmission request, a path with a time delay less than or equal to the delay duration, as the data transmission path, where the time delay includes a sum of the processing delay(s) and the transmission delay(s) of the router(s) passed through for reaching the destination address; or
searching for, from the network topology information and based on the source address, the destination address and the delay duration in the data transmission request, a path with a time delay less than or equal to the delay duration, as the data transmission path, where the time delay includes a sum of the processing delay(s) and the transmission delay(s) of the router(s) passed through for reaching the destination address from the source address.

In some embodiments, searching for, from the network topology information, the path with the time delay less than or equal to the delay duration, as the data transmission path includes, but is not limited to at least one of the following:
selecting, in response to the number of the paths with the time delay less than or equal to the delay duration being at least two, the path with the smallest time delay as the data transmission path; or
selecting, in response to the number of the paths with the time delay less than or equal to the delay duration being at least two, the path that passes through the least number of routers as the data transmission path.

In some embodiments of the present disclosure, the data transmission path may be the data transmission path described in the step S42, which is not repeated herein.

In this way, in the embodiment of the present disclosure, based on the destination address and the delay duration in the data transmission request, or based on the source address, the destination address, and the delay duration in the data transmission request, the suitable path for reaching the destination address may be searched out from the network topology information as the data transmission path. Moreover, if there is a plurality of suitable paths, the path with the smallest time delay may be selected from the paths as the data transmission path, causing that a more suitable data transmission path may be obtained, thereby accelerating the transmission rate of the information packet and improving the transmission efficiency of the information packet. Alternatively, if there is a plurality of suitable paths, the path that passes through the least number of routers may be selected from the paths as the data transmission path, causing that a more suitable data transmission path may be obtained, thereby reducing the network resources occupied by the transmission of the information packet, and the like.

In other embodiments, in response to the number of the paths with the time delay less than or equal to the delay duration being at least two, any one of the paths may be selected as the data transmission path. In this way, it is also possible to precisely determine the data transmission path for the information packet to reach the destination address or to reach the destination address from the source address, as well as the required time delay.

The methods provided by an embodiment of the present disclosure may be performed alone, or in conjunction with some of the methods of the other embodiments of the present disclosure or some of the methods of the related arts.

As shown in FIG. 7, an embodiment of the present disclosure provides a network path determining method. The method is applied to a router, and includes the following step S71.

At step S71, the network topology information is generated based on network information of the router and routing information of the router.

In some embodiments, the network information includes, but is not limited to, at least one of the following:
an address of a device connected to the router; or
a transmission delay for reaching a device connected to the router.

In an embodiment, the device at least includes one of: the sender UE, the receiver UE and another router in a network where the router is located.

In some embodiments, the routing information includes, but is not limited to, one of the following:
a transmission delay between any two routers; or
a processing delay of the router.

In an example, if the first-hop router connects to the sender UE and the second-hop router, the network information obtained by the first-hop router may include at least one of the following: an address of the first-hop router, an address of the second-hop router, an address of the sender UE, and a transmission delay for reaching the first-hop router from the sender UE; and the routing information obtained by the first-hop router may include at least one of the following: a processing delay of the first-hop router, a processing delay of the second-hop router, and a transmission delay for reaching the second-hop router from the first-hop router.

In an example, if the second-hop router connects to the first-hop router and the sender UE, the network information obtained by the second-hop router may include at least one of the following: an address of the first-hop router, an address of the second-hop router, an address of the receiver UE, and a transmission delay for reaching the receiver UE from the second-hop router; and the routing information obtained by the second-hop router includes at least one of the following: a transmission delay for reaching the second-hop router from the first-hop router, a processing delay of the first-hop router, and a processing delay of the second-hop router.

In an embodiment, the router may directly obtain the address(es) and processing delay(s) of the other device(s) connected to the router itself, and obtain the transmission delay(s) for reaching the device(s) connected to the router itself.

Of course, in the above example, if the network also includes other routers, such as a third-hop router and a fourth-hop router, and the first-hop router connects to the second-hop router but not to the third-hop router or the fourth-hop router, the network information obtained by the first-hop router may also include at least one of the following: an address of the third-hop router and an address of the fourth-hop router; and the routing information obtained by the first-hop router may also include at least one of the following: a transmission delay for reaching the third-hop router from the first-hop router, a processing delay of the third-hop router, and a transmission delay for reaching the fourth-router from the first-hop router. Herein, an address and a processing delay of a router that is not connected to the first-hop router, as well as the transmission delay for reaching a router that is not connected to first-hop router, may be obtained, from these routers based on a routing protocol, by the first-hop router. For example, the address and the processing delay of the third-hop router may be obtained by the first-hop router from the third-hop router.

In an embodiment, a router may also indirectly obtain an address and a processing delay of another device that is not connected to the router, as well as the transmission delay for reaching the another device.

In these embodiments of the present disclosure, a router may obtain the network information of the device connected to the router, and obtain the routing information, causing that comprehensive network topology information is obtained, and providing a basis for subsequently determining an accurate data transmission path based on the network topology information. Moreover, in the embodiments of the present disclosure, the router may also obtain the network information of the device in the network that does not connect to the router, and the routing information of another router that does not connect to the router, causing that more comprehensive network topology information is obtained, and providing a more comprehensive and accurate basis for subsequently determining a data transmission path based on the network topology information; and more suitable data transmission paths may be obtained.

The methods provided by an embodiment of the present disclosure may be performed alone, or in conjunction with some of the methods of the other embodiments of the present disclosure or some of the methods of the related arts.

As shown in FIG. 8, an embodiment of the present disclosure provides a network path determining method. The method is applied to a router, and includes the following step S81.

At step S81, a data transmission path is sent. In an embodiment, the data transmission path is used for being sent, through being carried in an information packet to be sent, by a UE.

In some embodiments of the present disclosure, the data transmission path may be the data transmission path described in the step S42, which is not repeated herein.

An embodiment of the present disclosure provides a network path determining method. The method may include: sending, by the first-hop router, the data transmission path to the sender UE.

An embodiment of the present disclosure provides a network path determining method. The method may include: sending, by the next-hop router, the data transmission path to the previous-hop router. For example, the second-hop router sends the data transmission path to the first-hop router.

In an embodiment, the information packet includes an IP information packet. In other embodiments, the information packet may be any type of information packet. The information packet is used for transmitting data and/or instructions, etc.

In an embodiment, the information packet includes: an address of the next-hop router, a transmission delay for reaching the next-hop router, a processing delay of the next-hop router, a transmission delay for reaching the destination address from the last-hop router, and the destination address.

In another embodiment, the information packet includes: the source address, the transmission delay from the source address to the first-hop router, the address(es) and processing delay(s) of the router(s) passed through, the transmission delay for reaching the next-hop router or the destination address from the previous-hop router, and the destination address.

In some embodiments of the present disclosure, the data transmission path may be sent to the sender UE by the router, which may enable the sender UE to know the transmission path of the information packet and the time delay of the transmission of the information packet, etc., realizing the precise control of the time and the path of the information packet during transmission.

The methods provided by an embodiment of the present disclosure may be performed alone, or in conjunction with some of the methods of the other embodiments of the present disclosure or some of the methods of the related arts.

It is noted herein that the following network path determining methods, which are applied to a UE, are similar to the above description of the network path determining methods applied to a router. For technical details not disclosed in the embodiments of the network path determining methods applied to the UE in the present disclosure, please refer to the description of the embodiments of the network path determining methods applied to the router in the present disclosure, which is not described in detail herein.

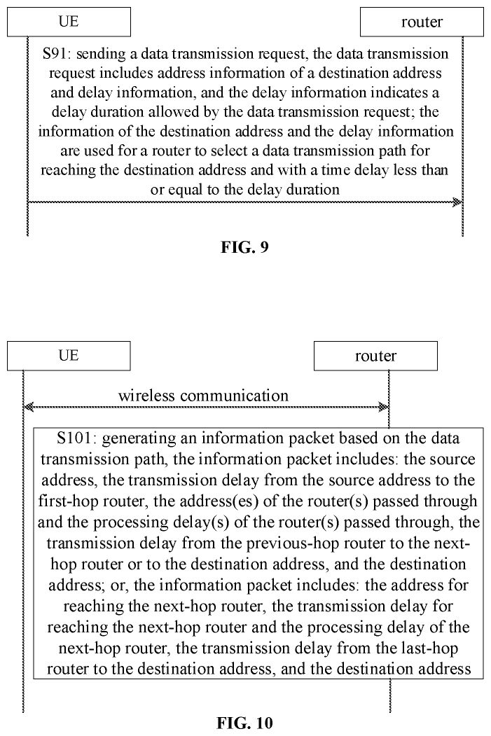

As shown in FIG. 9, an embodiment of the present disclosure provides a network path determining method. The method is applied to a UE, and includes the following step S91.

At step S91, a data transmission request is sent. In an embodiment, the data transmission request includes a destination address and delay information, and the delay information indicates a delay duration allowed by the data transmission request.

In an embodiment, information of the destination address and the delay information are used for a router to select a data transmission path for reaching the destination address and with a time delay less than or equal to the delay duration.

An embodiment of the present disclosure provides a network path determining method. The method may include: the sender UE sends the data transmission request to the first-hop router.

An embodiment of the present disclosure provides a network path determining method. The method may include: the previous-hop router sends the data transmission request to the next-hop router.

In some embodiments of the present disclosure, a UE may send the data transmission request to a router, causing the router to be able to determine, based on the destination address and the delay information included in the data transmission request, the data transmission path for reaching the destination address and with the time delay less than or equal to the delay duration indicated by the delay information, and in this way, the data transmission path for the data transmission and the time delay for the data transmission can be accurately determined.

An embodiment of the present disclosure provides a network path determining method. The method may include receiving the data transmission path, and the data transmission path includes one or more addresses of routers passed through for reaching the destination address.

In some embodiments, the data transmission request further includes address information of a source address.

In these embodiments, the data transmission path includes one or more addresses of routers passed through for reaching the destination address from the source address.

An embodiment of the present disclosure provides a network path determining method. The method may include: sending a data transmission request. In an embodiment, the data transmission request includes address information of a source address, a destination address and delay information, and the delay information indicates a delay duration allowed by the data transmission request. The address information of the source address, the information of the destination address and the delay information are used for a router to select a data transmission path for reaching the destination address from the source address and with a time delay less than or equal to the delay duration.

In the embodiments of the present disclosure, a UE may send the data transmission request to a router, causing the router to be able to determine, based on the data transmission request, the data transmission path for reaching the destination address from the source address and with the time delay less than or equal to the delay duration, and in this way, the data transmission path and the time delay for the data transmission can be accurately determined.

The methods provided by an embodiment of the present disclosure may be performed alone, or in conjunction with some of the methods of the other embodiments of the present disclosure or some of the methods of the related arts.

As shown in FIG. 10, an embodiment of the present disclosure provides a network path determining method. The method is applied to a UE, and includes the following step S101.

At step S101, an information packet is generated based on the data transmission path. In an embodiment, the information packet includes: the source address, the transmission delay from the source address to the first-hop router, the address(es) of the router(s) passed through and the processing delay(s) of the router(s) passed through, the transmission delay from the previous-hop router to the next-hop router or to the destination address, and the destination address; or, the information packet includes: the address for reaching the next-hop router, the transmission delay for reaching the next-hop router and the processing delay of the next-hop router, the transmission delay from the last-hop router to the destination address, and the destination address.

In an example, if the data transmission path is: router 1, router 2, and the receiver UE, the information packet may include: an address of router 1, an address of router 2, a transmission delay for reaching router 2, a processing delay of router 2, an address of the receiver UE, and a transmission delay for reaching the receiver UE; or, the information packet may include: an address of router 1, a processing delay of a router 1, an address of router 2, a transmission delay for reaching router 2, a processing delay of router 2, an address of the receiver UE, and a transmission delay for reaching the receiver UE.

In an example, if the data transmission path is: the source address, router 1, router 2, and the receiver UE, the information packet may include: the source address, an address of router 1, a transmission delay for reaching router 1, a processing delay of router 1, an address of router 2, a transmission delay for reaching router 2, a processing delay of router 2, an address of the receiver UE, and a transmission delay for reaching the receiver UE.

In an example, if the data transmission path is: the source address, router 1, router 2 . . . router N, and the receiver UE, the information packet may include: the source address, an address of router 1, a transmission delay for reaching router 1, a processing delay of router 1, an address of router 2, a transmission delay for reaching router 2, a processing delay of router 2 . . . an address of router N, a transmission delay for reaching router N, a processing delay of router N, an address of the receiver UE, and a transmission delay for reaching the receiver UE. N herein is an integer greater than or equal to 2.

In an embodiment, if the data transmission path passes through N routers, the number of hops that the data transmission path passes through is N+1 hops.

In an embodiment of the present disclosure, the UE may also determine, based on the information packet, a time delay for the information packet to be transmitted based on the data transmission path.

In some embodiments of the present disclosure, based on the generated information packet, it is possible to know exactly the data transmission path that the information packet passes through, for example, it is possible to know how many routers the information packet needs to pass through in total, from which source address device to which destination address device or reaching which destination address device, and how many hops the information packet passes through, etc.; and it is possible to know the transmission delay for the information packet to reach the respective router or the UE indicated by the destination address, the processing delay of the respective router passed through, and the total time delay for the transmission of the information packet. In this way, the precise control of the data transmission path and the time delay for the transmission of the information packet is realized.

The methods provided by an embodiment of the present disclosure may be performed alone, or in conjunction with some of the methods of the other embodiments of the present disclosure or some of the methods of the related arts.

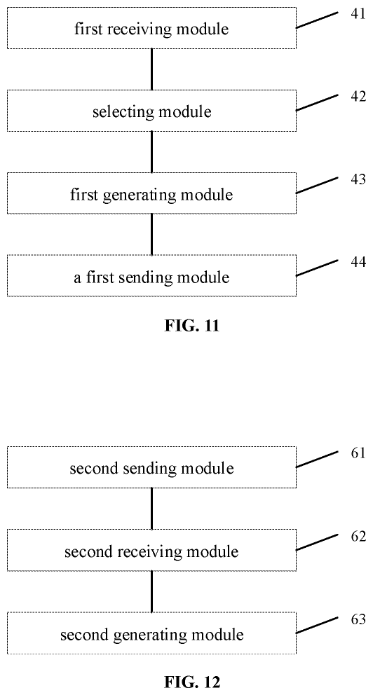

As shown in FIG. 11, an embodiment of the present disclosure provides a network path determining apparatus. The apparatus is applied to a router, and includes:
a first receiving module 41, configured to receive a data transmission request, the data transmission request includes a destination address and delay information, and the delay information indicates a delay duration allowed by the data transmission request; and
a selecting module 42, configured to select, based on the destination address and the delay information, a data transmission path for reaching the destination address and with a time delay less than or equal to the delay duration.

In some embodiments, the data transmission path includes one or more addresses of routers passed through for reaching the destination address.

An embodiment of the present disclosure provides a network path determining apparatus. The apparatus is applied to a router, and may include:
a first receiving module 41, configured to receive a data transmission request, the data transmission request includes address information of a source address, a destination address and delay information, and the delay information indicates a delay duration allowed by the data transmission request; and
a selecting module 42, configured to select, based on the address information of the source address, the destination address and the delay information, a data transmission path for reaching the destination address from the source address and with a time delay less than or equal to the delay duration.

In some embodiments, the data transmission path includes one or more addresses of routers passed through for reaching the destination address from the source address.

In some embodiments, the time delay includes:
a processing delay, used for indicating a duration of data processing performed by the router; and
a transmission delay, used for indicating at least one of: a duration of reaching a first-hop router from a sender UE, a duration of reaching a next-hop router from a previous-hop router, and a duration of reaching a receiver UE from a last-hop router.

An embodiment of the present disclosure provides a network path determining apparatus. The apparatus is applied to a router, and may include:
a selecting module 42, configured to: determine the transmission delay based on the delay duration and the processing delay; and determine the data transmission path based on the transmission delay and network topology information.

An embodiment of the present disclosure provides a network path determining apparatus. The apparatus is applied to a router, and may include:
a first generating module 43, configured to generate the network topology information based on network information of the router and routing information of the router.

In some embodiments, the network information includes at least one of the following:
an address of a device connected to the router; or
a transmission delay for reaching a device connected to the router.

In an embodiment, the device at least includes one of the following: the sender UE, the receiver UE and another router in a network where the router is located.

In some embodiments, the routing information includes one of the following:
a transmission delay between any two routers; or
the processing delay of the router.

An embodiment of the present disclosure provides a network path determining apparatus. The apparatus is applied to a router, and may include:
a first sending module 44, configured to send the data transmission path. The data transmission path is used for being sent, through being carried in an information packet to be sent, by a UE.

The apparatus provided by an embodiment of the present disclosure may be performed alone, or in conjunction with some of the apparatus of the other embodiments of the present disclosure or some of the apparatus of the related arts.

As shown in FIG. 12, an embodiment of the present disclosure provides a network path determining apparatus. The apparatus is applied to a UE, and includes:
a second sending module 61, configured to send a data transmission request. In an embodiment, the data transmission request includes a destination address and delay information, and the delay information indicates a delay duration allowed by the data transmission request.

In an embodiment, information of the destination address and the delay information are used for a router to select a data transmission path for reaching the destination address and with a time delay less than or equal to the delay duration.

An embodiment of the present disclosure provides a network path determining apparatus. The apparatus is applied to a UE, and may include:
a second receiving module 62, configured to receive the data transmission path. In an embodiment, the data transmission path includes one or more addresses of routers passed through for reaching the destination address.

In some embodiments, the data transmission request further includes address information of a source address.

In these embodiments, the data transmission path includes one or more addresses of routers passed through for reaching the destination address from the source address.

An embodiment of the present disclosure provides a network path determining apparatus. The apparatus is applied to a UE, and may include:
a second generating module 63, configured to generate an information packet based on the data transmission path.

In an embodiment, the information packet includes: the source address, the transmission delay from the source address to the first-hop router, the address(es) of the router(s) passed through and the processing delay(s) of the router(s) passed through, the transmission delay from the previous-hop router to the next-hop router or to the destination address, and the destination address; or the information packet includes: an address for reaching the next-hop router, the transmission delay for reaching the next-hop router and the processing delay of the next-hop router, the transmission delay from the last-hop router to the destination address, and the destination address.

The apparatus provided by an embodiment of the present disclosure may be performed alone, or in conjunction with some of the apparatus of the other embodiments of the present disclosure or some of the apparatus of the related arts.

With respect to the apparatus in the above embodiments, the specific ways in which the individual modules perform the operations have been described in detail in the embodiments relating to the method, and will not be described in detail herein.

An embodiment of the present disclosure provides a communication device. The communication device includes:
a processor; and
a memory, configured to store an executable instruction executable by the processor.

The processor, when executing the executable instruction, is configured to implement the network path determining method according to any one of embodiments of the present disclosure.

The communication device herein may be a router or a UE.

The processor may include various types of storage medium. The storage medium may be non-transitory computer storage medium capable of continuing to memorize information stored therein after the UE is powered down.

The processor may be connected to the memory via a bus, etc., for reading an executable program stored in the memory, e.g., at least one of the methods shown in FIGS. 4 to 10.

An embodiment of the present disclosure also provides a computer storage medium. The computer storage medium stores a computer executable program, and the executable program, when executed by a processor, implements the network path determining method according to any one of embodiments of the present disclosure, e.g., at least one of the methods shown in FIGS. 4 to 10.

With respect to the device and storage medium in the above embodiments, the specific ways in which the individual modules perform the operations have been described in detail in the embodiments relating to the method, and will not be described in detail herein.

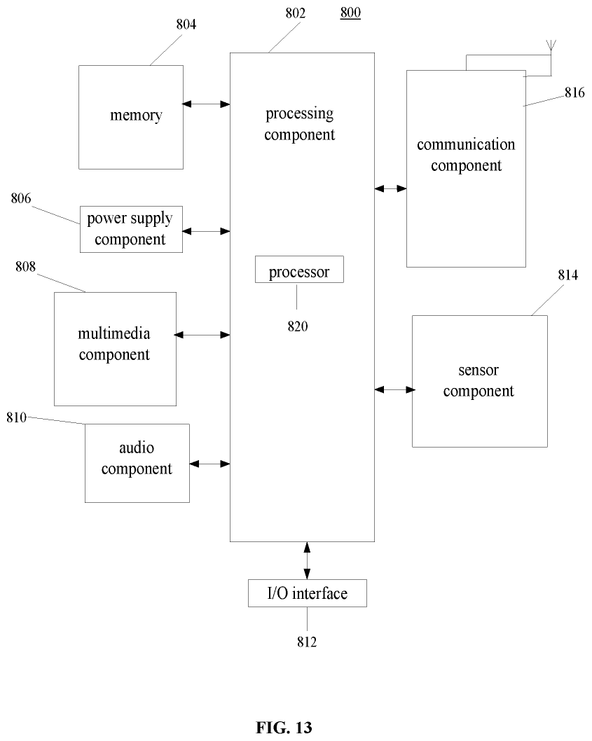

FIG. 13 is a block diagram of a UE 800 illustrated according to an embodiment. For example, the UE 800 may be a cell phone, a computer, a digital broadcasting subscriber device, a message transceiver device, a gaming console, a tablet device, a medical device, a fitness device, a personal digital assistant, and the like.

Referring to FIG. 13, the UE 800 may include one or more of the following components: a processing component 802, a memory 804, a power supply component 806, a multimedia component 808, an audio component 810, an input/output (I/O) interface 812, a sensor component 814, and a communication component 816.

The processing component 802 generally controls the overall operation of the UE 800, such as operations associated with display, telephone calls, data communication, camera operations, and recording operations. The processing component 802 may include one or more processors 820 to execute an instruction to complete all or some of the steps of the methods described above. In addition, the processing component 802 may include one or more modules that facilitate interaction between the processing component 802 and other components. For example, the processing component 802 may include a multimedia module to facilitate interaction between the multimedia component 808 and the processing component 802.

The memory 804 is configured to store various types of data to support the operations at the UE 800. Examples of such data include the following for any application or method to operate on the UE 800: instructions, contact data, phonebook data, messages, pictures, videos, etc. The memory 804 may be implemented by any type of volatile or non-volatile storage device or a combination thereof, such as a static random access memory (SRAM), electrically erasable programmable read-only memory (EEPROM), erasable programmable read-only memory (EPROM), programmable read-only memory (PROM), read-only memory (ROM), magnetic memory, flash memory, disk or CD-ROM.

The power supply component 806 supplies power to various components of the UE 800. The power supply component 806 may include a power supply management system, one or more power supplies, and other components associated with generating, managing, and distributing power for the UE 800.

The multimedia component 808 includes a screen that provides an output interface between the UE 800 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensors may not only sense the boundaries of the touch or swipe action, but also detect the duration and pressure associated with the touch or swipe action. In some embodiments, the multimedia component 808 includes a front-facing camera and/or a rear-facing camera. The front-facing camera and/or the rear-facing camera may receive external multimedia data when the UE 800 is in an operating mode, such as a shooting mode or a video mode. Each of the front-facing camera and the rear-facing camera may be a fixed optical lens system or have a focal length and optical zoom capability.

The audio component 810 is configured to output and/or input audio signals. For example, the audio component 810 includes a microphone (MIC), configured to receive external audio signals when the UE 800 is in an operating mode, such as a call mode, a recording mode, and a voice recognition mode. The received audio signals may be further stored in the memory 804 or sent via the communication component 816. In some embodiments, the audio component 810 further includes a speaker for outputting the audio signals.

The I/O interface 812 provides an interface between the processing component 802 and a peripheral interface module, and the peripheral interface module may be a keypad, a click wheel, a button, etc. These buttons may include, but are not limited to, a home button, a volume button, a start button, and a lock button.

The sensor component 814 includes one or more sensors, used for providing a status assessment of various aspects of the UE 800. For example, the sensor component 814 may detect an open/closed state of the UE 800, relative positioning of the component, for example, the component is the display and keypad of the UE 800, the sensor component 814 may also detect a change in the position of the UE 800 or a change in the position of one component of the UE 800, the presence or absence of user contact with the UE 800, the orientation or acceleration/deceleration of the UE 800, and temperature changes of the UE 800. The sensor component 814 may include a proximity sensor, configured to detect the presence of nearby objects in the absence of any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate the communication between the UE 800 and other devices by wired or wireless means. The UE 800 may access a wireless network based on a communication standard, such as Wi-Fi, 2G, 3G or a combination thereof. In an embodiment, the communication component 816 receives broadcast signals or broadcast-related information from an external broadcast management system via a broadcast channel. In an embodiment, the communication component 816 further includes a near-field communication (NFC) module to facilitate short-range communication. For example, the NFC module may be implemented based on a radio frequency identification (RFID) technology, infrared data association (IrDA) technology, ultra-wideband (UWB) technology, bluetooth (BT) technology, and other technologies.

In an embodiment, the UE 800 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic elements, and configured to perform the above methods.

In an embodiment, a non-transitory computer-readable storage medium including an instruction is provided, such as a memory 804 including an instruction. The instruction described above is capable of being executed by the processor 820 of the UE 800 to complete the above methods. For example, the non-transitory computer-readable storage medium may be a ROM, a random access memory (RAM), a CD-ROM, a magnetic tape, a floppy disk, an optical data storage device, etc.

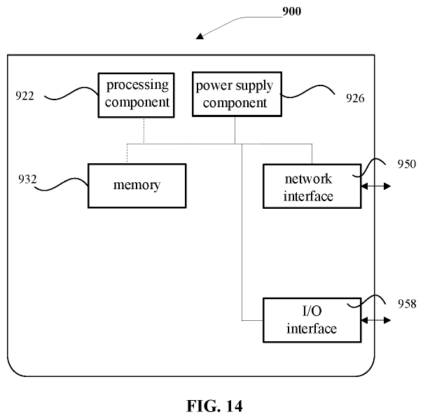

As shown in FIG. 14, an embodiment of the present disclosure illustrates a structure of a base station. For example, the base station 900 may be provided as a network side device. Referring to FIG. 14, the base station 900 includes a processing component 922. The processing component 922 further includes one or more processors, and a memory resource represented by a memory 932 for storing instructions, such as an application program, that is executable by the processing component 922. The application program stored in the memory 932 may include one or more modules each corresponding to a set of instructions. In addition, the processing component 922 is configured to execute the instructions to perform any of the methods described above applied to the base station, for example, the methods shown in FIGS. 4 to 10.

The base station 900 may also include a power supply component 926, a wired or wireless network interface 950, and an input/output (I/O) interface 958. The power supply component 926 is configured to perform power management for the base station 900. The wired or wireless network interface 950 is configured to connect the base station 900 to a network. The base station 900 may operate an operating system stored in the memory 932, such as Windows Server™, Mac OS X™, Unix™, Linux™, FreeBSD™ or the like.

The technical solutions provided by the embodiments of the present disclosure may include the following beneficial effects.

In some embodiments of the present disclosure, a data transmission request may be received by a router. The data transmission request includes a destination address and delay information. The delay information indicates a delay duration allowed by the data transmission request. A data transmission path for reaching the destination address and with a time delay less than or equal to the delay duration is selected based on the destination address and the delay information. In this way, the embodiments of the present disclosure are able to accurately determine the data transmission path and the time delay for the data transmission, for example, accurately determining the router passed through by the information packet for reaching the destination address, and determining the time delay for reaching the destination address.

The present disclosure is intended to cover any variations, uses, or adaptive changes of the present disclosure, which follow the general principles of the present disclosure and include common knowledge or commonly used technical means in the technical field that are not disclosed in the present disclosure. The specification and embodiments are only considered illustrative, and the true scope and spirit of the present disclosure are indicated by the following claims.

It is to be understood that the present disclosure is not limited to the precise structure which has been described above and illustrated in the accompanying drawings, and that various modifications and alterations may be made without departing from the scope of the present disclosure. The scope of the present disclosure is limited only by the appended claims.

1. network path determining method, comprising:
receiving, by a router, a data transmission request, the data transmission request comprising a destination address and delay information, and the delay information indicating a delay duration allowed by the data transmission request; and
selecting, by the router based on the destination address and the delay information, a data transmission path for reaching the destination address with a time delay less than or equal to the delay duration.

2. The method according to claim 1, wherein the data transmission path comprises an address of at least one router passed through for reaching the destination address.

3. The method according to claim 1, wherein the data transmission request further comprises a source address; and
selecting the data transmission path comprises:
selecting, based on the source address, the destination address and the delay information, the data transmission path for reaching the destination address from the source address.

4. The method according to claim 3, wherein the data transmission path comprises an address of at least one router passed through for reaching the destination address from the source address.

5. The method according to claim 2, wherein the time delay comprises:
a processing delay, indicating a duration of data processing performed by the at least one router; and
a transmission delay, indicating at least one of: a duration of reaching a first-hop router from a sender user equipment (UE), a duration of reaching a next-hop router from a previous-hop router, and a duration of reaching a receiver UE from a last-hop router.

6. The method according to claim 5, wherein selecting the data transmission path comprises:
determining the transmission delay based on the delay duration and the processing delay; and
determining the data transmission path based on the transmission delay and network topology information.

7. The method according to claim 6, further comprising:
generating the network topology information based on network information of the router and routing information of the router.

8. The method according to claim 7, wherein the network information comprises at least one of:
an address of a device connected to the router; or
a transmission delay for reaching a device connected to the router; wherein
the device at least comprises one of: the sender UE, the receiver UE and another router in a network where the router is located.

9. The method according to claim 7, wherein the routing information comprises one of:
a transmission delay between any two routers in a network where the router is located; or
a processing delay of any one router in a network where the router is located.

10. The method according to claim 1, further comprising:
sending the data transmission path to a UE which initiates the data transmission request, wherein the data transmission path carried in an information packet to be sent by the UE.

11. A network path determining method, comprising:
sending, by a user equipment (UE), a data transmission request, the data transmission request comprising a destination address and delay information, and the delay information indicating a delay duration allowed by the data transmission request,
wherein the destination address and the delay information are used for a router to select a data transmission path for reaching the destination address with a time delay less than or equal to the delay duration.

12. The method according to claim 11, further comprising:
receiving the data transmission path, wherein the data transmission path comprises an address of at least one router passed through for reaching the destination address.

13. The method according to claim 11, wherein the data transmission request further comprises a source address; and
the data transmission path comprises an address of at least one router passed through for reaching the destination address from the source address.

14. The method according to claim 13, further comprising:
generating an information packet based on the data transmission path,
wherein the information packet comprises: the source address, a transmission delay from the source address to a first-hop router, the address and a processing delay of the at least one router, a transmission delay from a previous-hop router to a next-hop router or to the destination address, and the destination address; or
the information packet comprises: an address of a next-hop router, a transmission delay for reaching the next-hop router and a processing delay of the next-hop router, a transmission delay from a last-hop router to the destination address, and the destination address.

15-28. (canceled)

29. A communication device, comprising:
a processor; and
a memory, configured to store an executable instruction executable by the processor; wherein
the processor, through-when executing the executable instruction, is configured to:
receive a data transmission request, the data transmission request comprising a destination address and delay information, and the delay information indicating a delay duration allowed by the data transmission request; and
select, based on the destination address and the delay information, a data transmission path for reaching the destination address with a time delay less than or equal to the delay duration.

30. A non-transitory computer storage medium, wherein the computer storage medium stores a computer executable program, and the executable program, when executed by a processor, implements the network path determining method according to claim 1.

31. The method according to claim 4, wherein the time delay comprises:
a processing delay, indicating a duration of data processing performed by the at least one router; and
a transmission delay, indicating at least one of: a duration of reaching a first-hop router from a sender user equipment (UE), a duration of reaching a next-hop router from a previous-hop router, and a duration of reaching a receiver UE from a last-hop router.

32. The method according to claim 8, wherein the routing information comprises one of:
a transmission delay between any two routers in a network where the router is located; or
a processing delay of any one router in a network where the router is located.

33. A communication device, comprising:
a processor; and
a memory, configured to store an executable instruction executable by the processor; wherein
the processor, through executing the executable instruction, is configured to implement the network path determining method according to claim 11.

34. A non-transitory computer storage medium, wherein the computer storage medium stores a computer executable program, and the executable program, when executed by a processor, implements the network path determining method according to claim 11.
